(19) United States
(12) Patent Application Publication
(10) Pub. No.: US 2019/0105524 A1
(43) Pub. Date: Apr. 11, 2019

(54) Rehabilitation and Mobility Improvement Apparatus and Method of Use

(71) Applicant: Korey K. Whitaker, Ogden, UT (US)

(72) Inventor: Korey K. Whitaker, Ogden, UT (US)

(21) Appl. No.: 16/214,075

(22) Filed: Dec. 8, 2018

(51) Int. Cl. A63B 21/055; A63B 23/12; A61H 1/02; A63B 21/00; A63B 21/04

(52) U.S. Cl. CPC A63B 21/0557; A63B 23/1209; A61H 1/0277; A61H 1/0281; A63B 21/0442; A63B 21/4005; A63B 21/4019; A63B 21/4025

(57) ABSTRACT

The present invention is a rehabilitation and mobility improvement apparatus (RMIA) and method of use for use in providing increased mobility in persons having reduced strength and mobility due to for instance injury or illness. The RMIA preferably defines a user wearable harness having at least one stretchable bungee cord and an appendage support device. The appendage support device is placed on a mobility reduced appendage (MRA) of the user allowing the user to exercise the MRA without needing to support the entire weight of the MRA. The RMIA is adjustable so as to alter resistance, to exercise a different MRA, and to accommodate users of different sizes.

### FIELD OF THE INVENTION

The present invention relates to rehabilitation devices, and more especially to device that provide for increased mobility in persons having injuries or illnesses that have otherwise caused decreased mobility in an extremity of such persons.

### BACKGROUND OF THE INVENTION

Many people having an injury or illness suffer from decreased mobility or range of motion in for instance an arm or a leg. Such reduction in mobility can result in atrophy of remaining viable good muscle tissue. Often, such persons, if they had a means of exercising their remaining good muscles, could increase their strength and mobility but for a means to engage in such exercise. For instance, if a person could move their arm in a swinging motion minimal or selectively variable resistance including less resistance than the full weight of the person's arm, such person could benefit from such exercise. However, because in most situations, a person must support the full weight of their arm, such person is not readily able to avail himself to such beneficial exercise. Various devices such as traction devices or crutches or the like are known and are used in rehabilitation in for persons having an injury or illness that has caused reduction of mobility in such persons. However, such devices are often highly specialized to a particular rehabilitation task and/or are relatively complex and/or expensive, and are not adapted to providing for the reduced resistance motion. An exemplary rehabilitation and mobility improvement apparatus is disclosed in U.S. Pat. No. 9,750,974, the entirety of which is incorporated herein by reference.

### SUMMARY OF THE INVENTION

The present invention is a rehabilitation and mobility improvement apparatus (RMIA) and method of use for use in providing increased mobility in persons having reduced strength and mobility due to for instance injury or illness. The RMIA preferably defines a user wearable harness having a plurality of loops secured thereto and a plurality of fastening anchor points. The RMIA further preferably includes at least one stretchable bungee cord or elastic cord having a hook secured to each (both) end of the cord and an appendage support device such as an adjustable sling or glove having a loop secured thereto. In practice, the appendage support device is placed on a hand, arm or other mobility reduced appendage (MRA) of the user. A first hook is engaged to a selected loop of the harness, and a second hook is engaged to the loop of the appendage support device. A user is then able to exercise an MRA without needing to support the entire weight of the MRA. Further, to increase or decrease resistance, to exercise a different MRA (i.e. left-hand versus right-hand), or to accommodate users of a different sizes, the RMIA may be readily adjusted by engaging the first hook into a different loop and or moving the appendage support device to a different part of the user's body. By the user moving the MRA through various swinging or extending and retracting cycles, the MRA may be strengthened and have mobility increased.

### DESCRIPTION OF DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a front view of a first embodiment of the invention being worn and used by a user with the user's arm in an pre-extend (flexion) exercise position;

FIG. 2 is a rear view of a first embodiment of the invention being worn and used by a user;

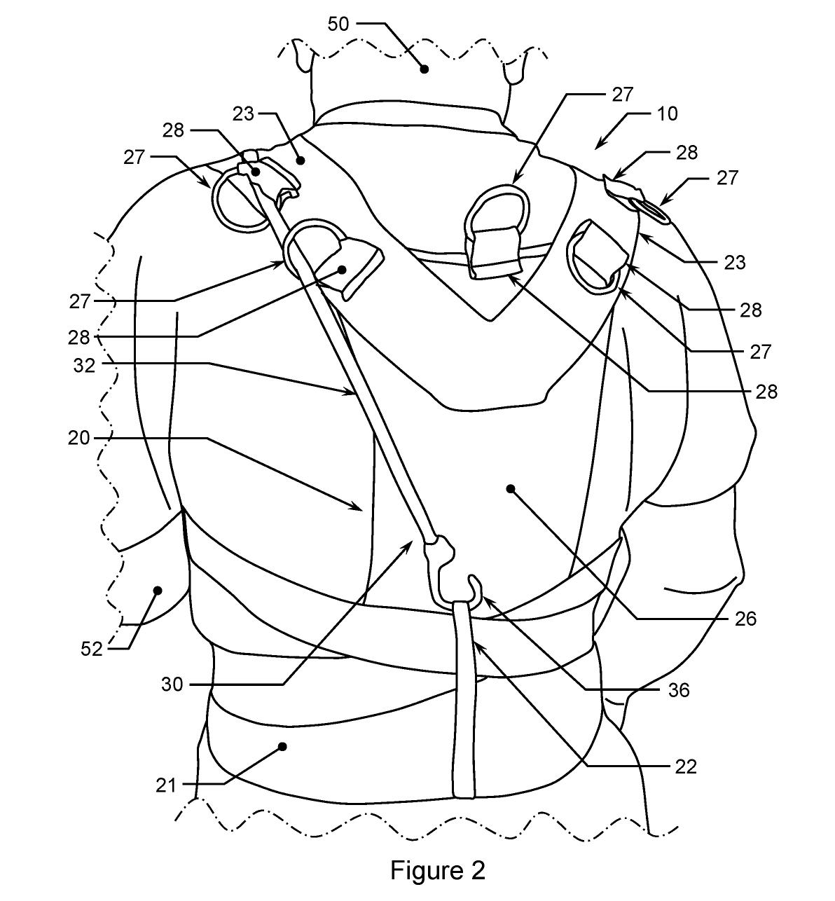

FIG. 3 is a top view of a first embodiment of the invention being worn and used by a user with the user's arm in a post-extend (extension) exercise position, and;

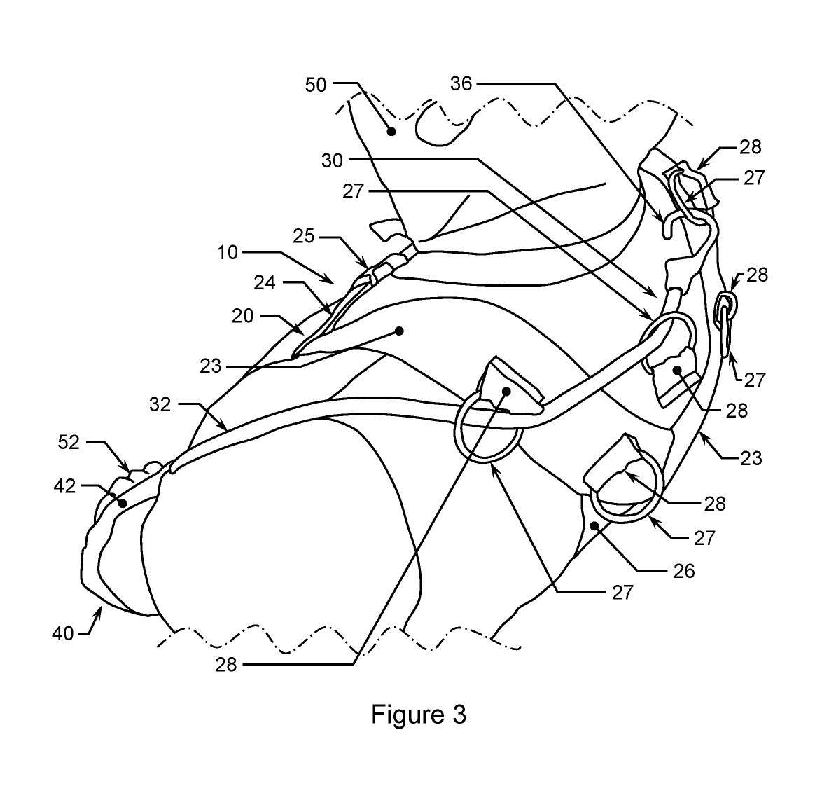

FIG. 4 is a side view of a first embodiment of the invention being worn and used by a user with the user's arm in a post-extended (extension) exercise position.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are included to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

In order to facilitate the understanding of the present invention in reviewing the drawings accompanying the specification, a feature list is provided below. It is noted that like features are like numbered throughout all of the figures.

FEATURE TABLE

| # | Feature | # | Feature |
|---|---|---|---|
| 10 | RMIA | | |
| 20 | Harness | 21 | Waist strap |
| 22 | Waist loop | 23 | Shoulder strap |
| 24 | Chest strap | 25 | Buckle |
| 26 | Back panel | 27 | Loop |
| 28 | Attach flange | | |
| 30 | Bungee cord | 32 | Cord |
| 34 | First hook | 36 | Second hook |
| 40 | Appendage support device | 42 | Strap |
| 44 | loop | 46 | Buckle |
| 50 | User | 52 | MRA |

Referring now to the drawings, the invention is a rehabilitation and mobility improvement apparatus (RMIA) 10 and method of use for use in providing increased mobility in persons having reduced strength and mobility due to for instance injury or illness, comprising a harness 20, a bungee cord 30, and appendage support device 40.

Harness 20 further defines a user wearable harness having a waist strap 21, a waist loop 22, a pair of shoulder straps 23, a chest strap 24, a buckle 25, a back panel 26, a plurality of loops 27, and a plurality of attach flanges 28. Waist strap 21, waist loop 22, shoulder straps 23, chest strap 24, back panel 26, and attach flanges 28 are all preferably constructed of a suitable strong flexible and breathable material such as nylon or a cotton nylon blend material. Waist strap 21 preferably includes a VELCRO or hook and loop fastener adapted so as to adjustably secure waist strap 21 to a user. Shoulder straps 23 are preferably adjustable so as to fit a variety of user sizes and so as to secure harness 20 to a user. Buckle 25 preferably defines a two-piece snap-together plastic buckle adapted so as to adjustably secure chest strap 24 so as to prevent slippage of shoulder straps 23 off of a user's shoulders. Loops 27 preferably define molded plastic loops or alternatively metal and more specifically steel loops. Loops 27 are preferably swivelably secured and interspersed to shoulder straps 23 and to back panel 26 by means of attach flanges 28.

Bungee cord 30 further defines a conventional off-the-shelf bungee cord having a stretchable elastic cord 32 with a first hook 34 secured to a first end of cord 32 and a second hook 36 secured to a second end of cord 32.

Appendage support device 40 further defines an adjustable MRA supporting device having a strap 42, a loop 44, and a buckle 46. Strap 42 is preferably constructed of a suitable strong flexible and breathable material such as nylon or a cotton nylon blend material. Strap 42 preferably includes a VELCRO or hook and loop fastener adapted so as to adjustably secure strap 42 to a MRA of a user. Loop 44 preferably defines a molded plastic loop or alternatively a metal and more specifically steel loop. Buckle 46 preferably defines a plastic buckle adapted so as to adjustably secure strap 42.

User 50 defines a user of RMIA 10. MRA (mobility reduced appendage) 52 defines a mobility reduced appendage of user 50 such as a mobility reduced hand, wrist, arm, leg, etc.

RMIA 10 is assembled such that cord 32 is threaded through one or more of loops 27, second hook 36 is hooked to waist loop 22, and first hook 34 is hooked to loop 44.

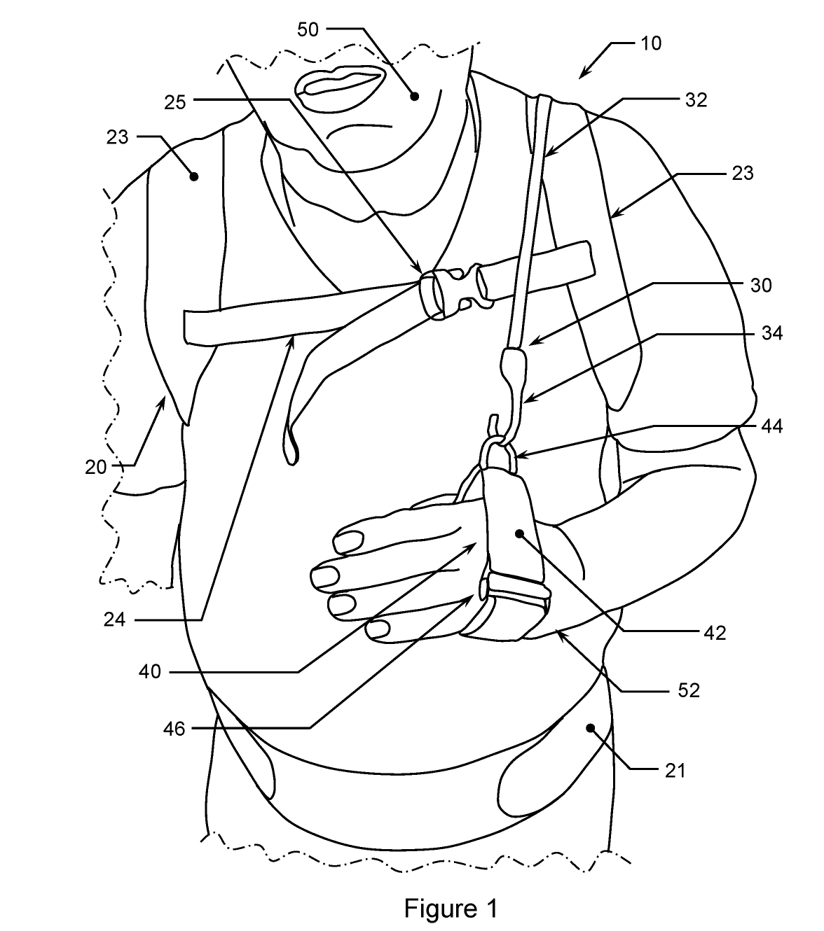

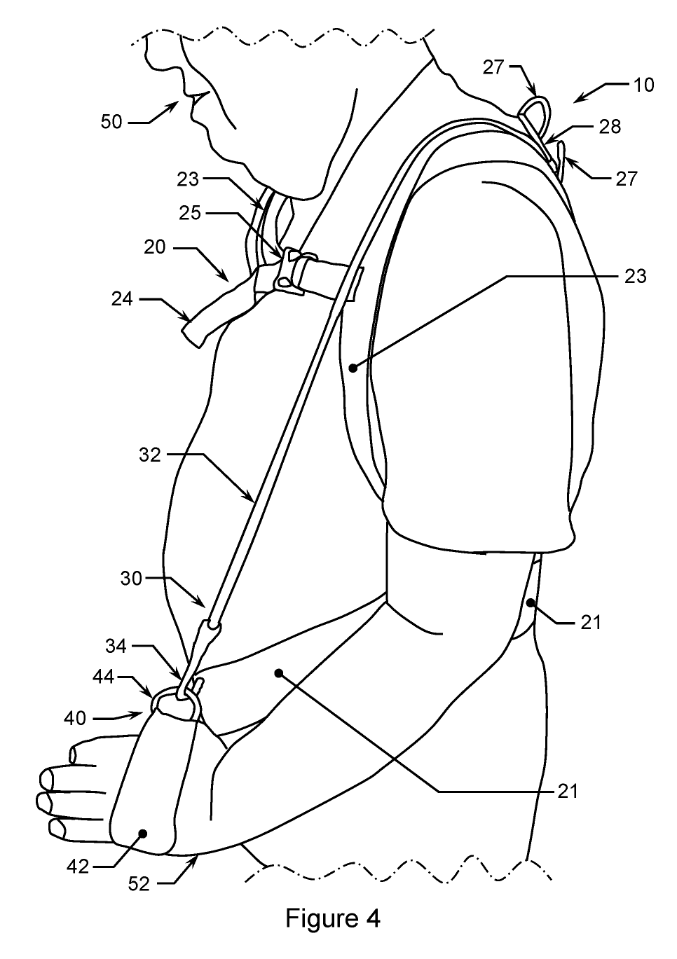

In practice, a user 50 (optionally with assistance of another person) dons RMIA 10 by placing the arms of user 50 through shoulder straps 23, and by placing waist strap 21 around the waist area of user 50. Shoulder straps 23 and waist strap 21 are preferably adjusted to the comfort of user 50, and waist strap 21 is preferably secured by means of a VELCRO or hook and loop fastener. Chest strap 24 is preferably adjusted to the comfort of user 50 and is secured in place by means of connecting buckle 25 so as to prevent shoulder straps 23 from falling off of user 50. Strap 42 of appendage support device 40 is place around MRA 52 (such as a hand, wrist, or arm of user 50) of user 50 and is adjusted to the comfort of user 50 and is secured in place by means of a VELCRO or hook and loop fastener. With RMIA 10 thus assembled to user 50, user 50 performs extension (such as shown in FIG. 4) and flexion (such as shown in FIG. 1) movements of MRA 52. When performing such extension and flexion movement of MRA 52, the full weight of MRA 52 is not required to be supported by user 50, thus enabling the “easing into” exercise or increasing exercise and mobility by degrees. Further, it should be noted that when performing an extension movement of MRA 52, work (exercise) is performed by stretching cord 32, and when performing a flexion movement of MRA 52, work (exercise) is performed by lifting MRA 52 albeit with assistance from the contraction of cord 32. If user 50 would like to increase or decrease the amount of resistance of cord 32 or if user 50 would like to readjust RMIA 10 so as to exercise in a different way or a different body member (e.g. left arm versus right arm) bungee cord 30 may be repositioned through a different set of loops 27 and second hook 36 may optionally be connected to a different part of RMIA 10 such as to a loop 27 of RMIA 10.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A rehabilitation and mobility improvement apparatus (RMIA) comprising a garment, a flexible connection member and an appendage support device, wherein said flexible connection member is connected to said garment on a first end and is connected to said appendage support device on a second end.

2. The RMIA of claim 1, wherein said garment defines a harness and said appendage support device defines at least one of a sling and a glove.

3. The RMIA of claim 1, wherein said garment includes a plurality of loops swivelably attached thereto, and wherein said appendage support device includes at least one loop swivelably attached thereto.

4. The RMIA of claim 1, wherein said flexible connection member defines an off-the-shelf bungee cord having a hook affixed to each end thereof.

5. The RMIA of claim 1, wherein said flexible connection member is repositionably connected to said garment.

6. The RMIA of claim 1, wherein said garment defines a harness having a plurality of loops swivelably attached thereto, and wherein said flexible connection member defines an off-the-shelf bungee cord having a hook affixed to each end thereof, said bungee cord being repositionably threaded through at least one of said loops.

7. The RMIA of claim 6, wherein said harness is configured to be attached to the torso of a user and said appendage support device is configured to be attached to an appendage of said user.

8. A rehabilitation and mobility improvement apparatus (RMIA) comprising a user wearable harness, a flexible resistance member and an appendage support device, wherein said flexible resistance member is repositionably connected to said harness on a first end and is removably connected to said appendage support device on a second end.

9. The RMIA of claim 8, wherein said harness includes a plurality of loops swivelably attached thereto, and wherein said appendage support device includes at least one loop swivelably attached thereto.

10. The RMIA of claim 8, wherein said flexible resistance member defines an off-the-shelf bungee cord having a hook affixed to each end thereof and wherein said appendage support device defines at least one of a sling and a glove.

11. The RMIA of claim 8, wherein said harness includes a plurality of loops swivelably attached thereto, and wherein said flexible resistance member defines an off-the-shelf bungee cord having a hook affixed to each end thereof, said bungee cord being repositionably threaded through at least one of said loops.

12. The RMIA of claim 11, wherein said harness is configured to be attached to the torso of a user and said appendage support device is configured to be attached to an appendage of said user.

13. A method of using a rehabilitation and mobility improvement apparatus (RMIA) comprising providing an RMIA having a garment, a flexible connection member and an appendage support device, wherein said flexible connection member is connected to said garment on a first end and is connected to said appendage support device on a second end, mounting said garment to a user and mounting said appendage support device to an appendage of said user, and moving said appendage such that said flexible connection member is flexed so as to provide for rehabilitation and improved mobility of said appendage.

14. The Method of claim 13, wherein said moving of said appendage defines a flexion and extension movement of said appendage.

15. The Method of claim 13, wherein said garment defines a harness and wherein said appendage support device defines at least one of a sling and a glove.

16. The Method of claim 13, wherein said garment includes a plurality of loops swivelably attached thereto, and wherein said appendage support device includes at least one loop swivelably attached thereto.

17. The Method of claim 13, wherein said flexible connection member defines an off-the-shelf bungee cord having a hook affixed to each end thereof.

18. The Method of claim 13, wherein said flexible connection member is repositionably connected to said garment.

19. The Method of claim 13, wherein said garment defines a harness having a plurality of loops swivelably attached thereto, and wherein said flexible connection member defines an off-the-shelf bungee cord having a hook affixed to each end thereof, said bungee cord being repositionably threaded through at least one of said loops.

20. The Method of claim 19, wherein said harness is configured to be attached to the torso of a user and said appendage support device is configured to be attached to an appendage of said user.
